(19) United States
(12) Patent Application Publication
(10) Pub. No.: US 2024/0114937 A1
(43) Pub. Date: Apr. 11, 2024

(54) METHOD FOR THE PRODUCTION OF MEAL FROM PLANT INGREDIENTS

(71) Applicant: INDUSTRIE ROLLI ALIMENTARI S.P.A., Roseto Degli Abruzzi (IT)

(72) Inventor: Lorenzo CERRETANI, Montesilvano (IT)

(21) Appl. No.: 18/263,823

(22) PCT Filed: Feb. 9, 2021
(86) PCT No.: PCT/IT2021/000004

§ 371 Date: Aug. 1, 2023

(51) Int. Cl. A23L 7/10; A23L 11/00; A23L 25/00

(52) U.S. Cl. CPC A23L 7/198; A23L 11/07; A23L 25/30

(57) ABSTRACT

A method for the production of vegetable flours, which includes the following steps:
identifying a vegetable with specific and predefined nutritional properties of interest and selecting those best suited for the production of flours;
performing a chemical, physical and pedological analysis of the soils intended for cultivation;
selecting natural seeds most suitable for the soil parameters;
performing checks on the vegetable species that grow after seeding;
performing at least one plant protection treatment;
and close to a harvesting period, performing iterated periodic spot checks of the vegetables. The method further includes the steps of
at the samplings in order to evaluate the residual concentration of active plant protection ingredients lower than 0.01 mg/kg, performing the harvesting of the cultivated vegetables;
performing a drying of the vegetables;
and grinding at least one part of the dried vegetable until a flour is obtained with a particle size distribution.

### CROSS-REFERENCE TO RELATED APPLICATIONS

This application is a 35 U.S.C. § 371 National Stage patent application of PCT/IT2021/000004, filed on 9 Feb. 2021, the disclosure of which is incorporated herein by reference in its entirety.

### TECHNICAL FIELD

The present disclosure relates to a method for the production of vegetable flours and to at least one respective vegetable flour obtained by means of said method.

### BACKGROUND

Flours of vegetable origin are becoming increasingly important in the food industry since they constitute one of the fundamental starting ingredients for a large number of recipes and foods: among these, mention must be made in particular of nutraceutical foods, foods for vegans (or vegetarians), foods for consumers who are intolerant to gluten and/or animal proteins and the like.

Currently, vegetable flours are very numerous and practically all have a high content of fundamental nutrients and fibers.

There are many vegetable flours that are part of cooking tradition and are already currently easily available, such as legume flours or cornmeal, and others that are more recent and have a more industrial origin, such as soya-bean flour.

These flours are used increasingly often in relation to the growing demand for healthy and balanced foods.

However, in many cases vegetable flours of the known type comprise residues of pesticides or other substances that are potentially harmful for human beings and derived from genetically modified vegetables (GMO). These problems significantly separate the commercially available products from what instead matches the expectations of customers.

### SUMMARY

The aim of the present disclosure is to solve the problems described above, providing a method for the production of vegetable flours that provides assurances regarding the absence of genetically modified organisms in the produced flours.

Within the scope of this aim, the disclosure provides a method for the production of vegetable flours that minimizes therein the presence of residues of pesticides.

the disclosure also provides a method for the production of vegetable flours that minimizes therein the presence of substances that are harmful for humans and animals.

The disclosure further provides a vegetable flour with optimum nutritional properties.

the disclosure also provides a vegetable flour with optimum organoleptic properties.

the present disclosure further provides a method for the production of vegetable flours and at least one respective vegetable flour that have low costs, are relatively simple to provide in practice and are safe in application.

This aim and these advantages, as well as others which will become better apparent hereinafter, are achieved by providing a method for the production of vegetable flours, characterized in that it includes the following steps:
identifying a vegetable with specific and predefined nutritional properties of interest and selecting, among all the existing vegetable varieties of said vegetable, the ones best suited for the production of flours;
performing a preliminary chemical, physical and pedological analysis of the soils intended for cultivation, in order to identify their composition, their hydrological characteristics, and to verify the absence of pathogens, pest organisms and pollutants;
selecting, among natural seeds that are not genetically modified, the ones most suitable for the soil parameters identified previously;
performing iterated periodic checks on the vegetable species that grow after seeding, in order to detect biotic adversities and/or infestations thereof;
performing at least one plant protection treatment by using active ingredients selected from insecticides, herbicides, acaricides, limacides and fungicides;
close to the harvesting period, performing iterated periodic spot checks of the vegetables in order to measure the residual concentration of active plant protection ingredients;
at the samplings in order to evaluate the residual concentration of active plant protection ingredients lower than 0.01 mg/kg, performing the harvesting of the cultivated vegetables;
performing a drying of the vegetables which comprises at least one step of pre-drying in the field and their harvesting;
grinding at least one part of the dried vegetable until a flour is obtained with a particle size distribution, understood as the average diameter of each individual particle of shredded vegetable, comprised between a few microns and 1.5 mm.

This aim and these advantages are also achieved by providing a vegetable flour, characterized in that it comprises particles of vegetables of the type obtained by natural selection and hybridization, i.e., not genetically modified, chosen among Leguminosae, Brassicaceae, Chenopodiaceae, Asteraceae, seeds and nuts, having
a residual concentration of active plant protection ingredients lower than 0.01 mg/kg,
a residual concentration of mycotoxins lower than 2000 μg/kg,
a residual concentration of heavy metals lower than 0.20 mg/kg.

### BRIEF DESCRIPTION OF THE DRAWINGS

Further characteristics and advantages of the disclosure will become better apparent from the description of a preferred but not exclusive embodiment of the method for the production of vegetable flours (and of the respective vegetable flours), illustrated by way of non-limiting example in the accompanying drawings, wherein:

FIG. 1 is a general diagram of a possible embodiment of the method for the production of vegetable flours according to the disclosure;

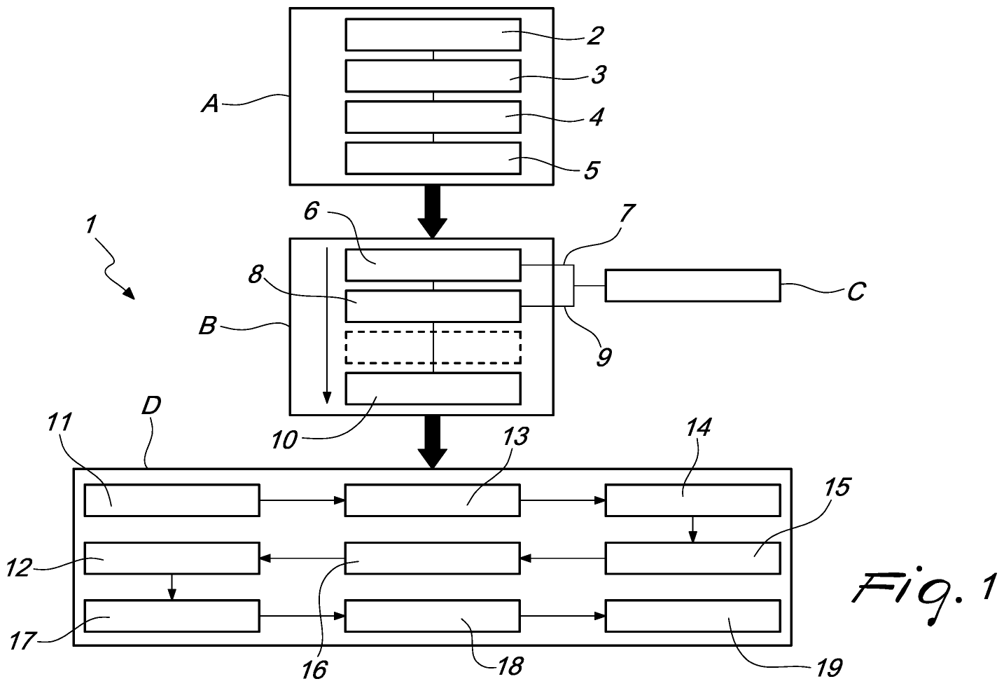

FIG. 2 is a general diagram of a further embodiment of the method for the production of vegetable flours according to the disclosure; and

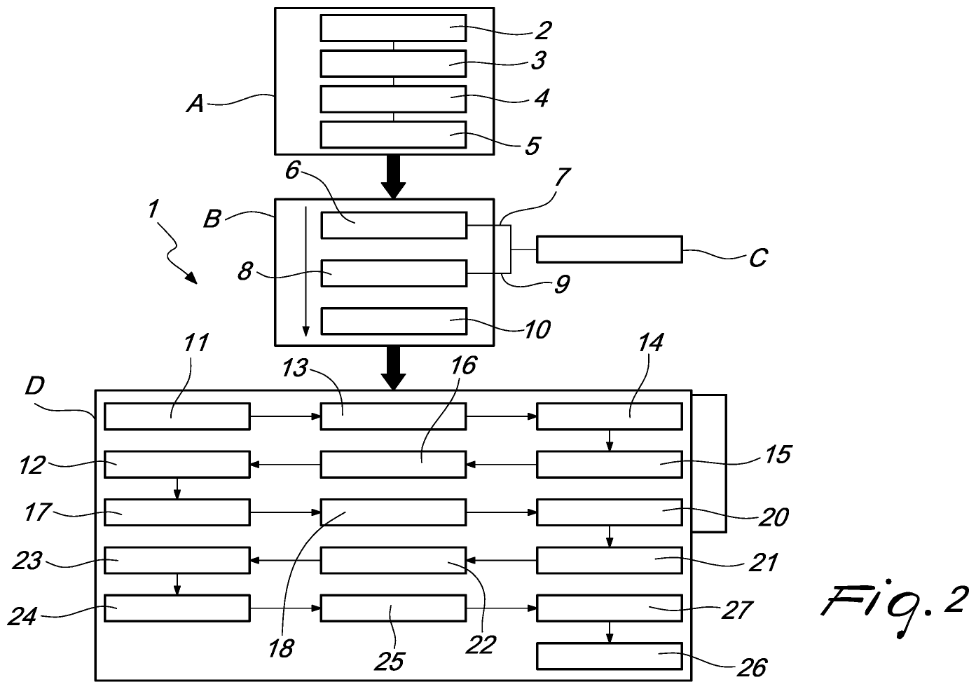

FIG. 3 is a diagram for the control and management of the cultivated fields that is adopted in the execution of the method according to the disclosure.

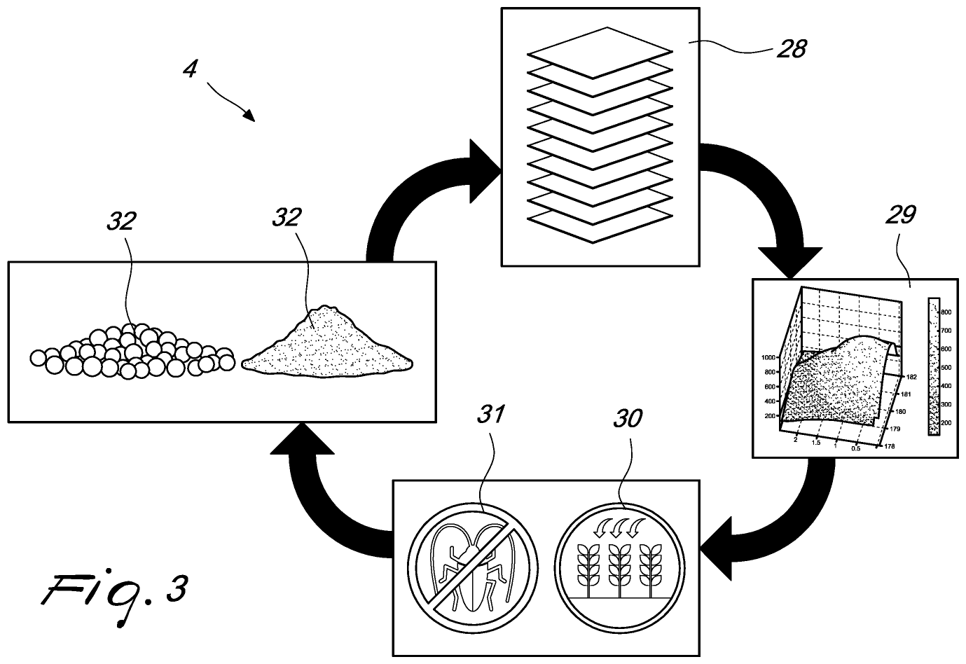

### DETAILED DESCRIPTION OF THE DRAWINGS

With reference to the figures, the reference numeral 1 generally designates a method for the production of vegetable flours.

The method for the production of vegetable flours according to the disclosure provides for a series of steps of agronomic scope (i.e., which provide for activities to be performed in the field and on the seeds) and a series of activities of industrial scope (i.e., which provide for processes to which the vegetables and the corresponding intermediate products are to be subjected in order to obtain the finished product).

During a first step 2 it is necessary to identify a vegetable with specific and predefined nutritional properties of interest.

Once the suitable vegetable has been identified, during a subsequent step 3, the selection of the varieties best suited for the production of flours, among all the existing vegetable varieties of said vegetable, is provided.

Then a preliminary chemical, physical and pedological analysis of the soils intended for cultivation is performed at a step 4 in order to identify their composition, their hydrological characteristics, and to verify the absence of pathogen agents, pest organisms, and pollutants.

During a step 5 it is necessary to select among the seeds of the vegetable most suited for the production of flours identified previously, choosing the exclusively natural variants of said seeds, i.e., the ones that are not genetically modified, in order to identify the ones best suited for the parameters of the soil identified previously.

In a substantially standard manner, it is possible to proceed with seeding (although it is not excluded to adopt typical criteria of precision agriculture also for the seeding step, in order to perform an uneven distribution of the seeds as a function of the characteristics of the soil, in order to obtain a uniform concentration of the vegetables on the soil itself).

Within a field it is very likely that production is not uniform, i.e., that there are regions where more is produced and others where less is produced. This variability in production can depend on many factors, as well as on an incorrect application of the fertilizer/amendment or by seeding performed incorrectly. Often, however, this variability is induced by elements which are so to speak objective, such as a different composition of the soil, the presence of hollows in which water stagnates, or of more compacted and therefore less porous regions. Being able to understand what generates the variability and therefore find the means to remedy it, when possible, or adapt the production process so as to reduce waste, is the task that precision agriculture or precision farming sets itself.

Variability occurs not only in space (distinct areas of a same field may have different chemical, physical and pedological characteristics) but also in time (cyclic and/or periodic evolutions of the soil through the course of the year or years). Managing variability means that the production process, once the information has been gathered, can be applied in a diversified manner. For example, where previously production was found to be lower than a reference level (or lower than that of other areas of the field on which one operates), it is possible to increase the use of fertilizer with the goal of stimulating the growth of the crop or vice versa reduce it if that given region has a reduced productivity due to non-modifiable inherent characteristics (for example the texture of the soil).

In order to adopt precision farming it is necessary to have techniques and technologies suitable for detecting the non-uniformity of the soil and designed for an uneven application of the steps for soil treatment, fertilization and seeding, which are in any case performed on the basis of the requirement of the specific crop.

Precision farming can use different strategies and technologies which can operate in a geo-referenced manner.

Geo-referencing is a method, by now well known to everyone, that allows to know the exact position during the execution of activities by virtue of the link to satellite devices.

It is useful here to remember that precision farming can be adopted at levels of rising complexity: assistance to driving, management of variability, traceability, etc.

Once seeding has been performed, step 6, it becomes necessary to perform periodic iterated checks (step 7) on the vegetable species that grow after seeding, in order to detect biotic adversities and/or infestations thereof.

Timeliness in obtaining the results of the checks provided in step 7 is important in order to be able to act effectively on the field in order to contrast the onset of molds, fungi or infestations of microorganisms or other harmful lifeforms. It should in fact be noted that if one has timely and delimited data available (which might be obtainable by means of methods which are typical of precision farming), it is possible to treat locally specific areas of the cultivated field in order to delimit the infestations at their onset, without the need to intervene on the entire field (with a consequent greater use of chemical or biological mixtures of various kinds, intended to fight infestations and contaminations).

In order to facilitate the optimum growth of the vegetables of interest it will be necessary to perform, during a step 8, at least one plant protection treatment, using active ingredients selected from insecticides, herbicides, acaricides, limacides, and fungicides.

Close to the harvesting period, it will be necessary to perform iterated periodic spot checks 9 of the vegetables in order to measure the residual concentration of active plant protection ingredients.

It is fundamental that in this step 9 the results of the measurements may be available already a few hours after the picking of the samples from the field (generally speaking, preferably within 24 hours, although for the purposes of the present method 1 it may be acceptable in some cases to obtain the results even 72 hours after picking).

The step 10 for harvesting the cultivated vegetables depends on the detection of a residual concentration of active plant protection ingredients lower than 0.01 mg/kg in the samples subjected to the checks of step 9.

It is appropriate to point out that in particular applications of the method 1 according to the disclosure, the harvesting of the cultivated vegetables may advantageously depend upon the detection of a residual concentration of active plant protection ingredients of less than 0.005 mg/kg (in the samples subjected to the checks of step 9), a condition that can occur in all cases in which the analytical method allows this identification for the specific pesticide molecule that is the subject of the investigation.

The vegetables, in order to be able to be converted into flour, must be subjected to at least one drying step 11, 12: in particular, it is possible to provide a pre-drying step 11 to be performed directly in the field (utilizing the sun and the atmospheric conditions) beforehand with respect to the step 10 for their harvesting.

At this point it is possible to provide an optional screening step 13, at which the vegetables can be selected, rejecting the defective products and eliminating foreign objects (residues of soil or of other vegetables or other portions of the vegetable of interest that are not useful).

This operation can be performed by means of an optical sorting (or digital sorting) system which provides for the screening and separation of solid products by means of video cameras (which are preferably chosen among those that can operate in the visible and/or infrared spectrum, although the adoption of lenses that are also sensitive to ultraviolet for specific applications is not excluded) and/or lasers.

Depending on the type of sensor used and on the intelligence managed by the software of the image processing system, optical selection devices can recognize the color, dimensions, shape, structural properties and chemical composition of the objects. The sorting device compares the vegetable products with predefined acceptance/rejection criteria in order to identify and remove the defective products and the foreign material from the production line. Optical selection devices are widely used in the food industry worldwide, with the highest adoption in the processing of harvested foods such as potatoes, fruit, vegetables and nuts, where it reaches a 100% nondestructive in line inspection with full production volumes. With respect to manual sorting, which is subjective and inconsistent, optical sorting helps to improve the quality of the product, maximize productivity increase yield by reducing labor costs.

At this point one can proceed with an optional washing and cleaning step 14, which is followed by a further optional humidification step 15 which can have a duration that can vary as a function of the specific characteristics of the vegetable of interest (in particular it is noted that in possible examples of application of the present disclosure illustrated herein by way of non-limiting example, the humidification step 15 might last for a time that can vary between a few seconds and a few tens of hours).

If one operates on vegetables that belong to Leguminosae or nuts, if one operates on seeds or on quinoa, there is a further decortication step (which is also optional since it is provided only for some types of vegetable).

The term decortication is understood to refer to the separation of the seeds (or part thereof) or of the fruits or of specific parts of some plants from the peel and/or shell that surrounds them.

If at least one of these optional steps 13, 14, 15, 16 has been performed, one then proceeds with the industrial drying step 12 (which is always provided as a supplement to the pre-drying step 11 which instead occurs in the field).

The industrial drying step 12 provides for the passage of the vegetable on air dryers at a temperature comprised between 30° and 90° C. for a time interval that can vary between a few minutes and 24 hours.

The goal is to reach a humidity of approximately 13-14% of the product in powder form.

If one operates on Leguminosae or nuts or on seeds or quinoa, the industrial drying step 12 might also be very short (on the order of a few minutes), providing temperatures close to the lower threshold of the interval cited earlier: this is possible since these vegetables reach, during the step 11 for pre-drying in the field, levels of residual humidity comprised between 5% and 20% (generally around 13/14%), levels which can be already deemed suitable for subsequent processes, without the need to introduce an intense industrial drying step 12.

For all vegetables comprising leaves (therefore for vegetables belonging to Chenopodiaceae, such as all the botanical varieties of Beta vulgaris and spinach, and Asteraceae, such as lettuce, dandelion, chicory, endive, thistle, artichoke, marigold), the industrial drying step 12 is performed preferably at a temperature comprised between 50° C. and 65° C. for a time interval that can vary between 5 hours and 15 hours.

For all vegetables belonging to Brassicaceae (such as for example cabbage, turnip, cauliflower, rapeseed, Brussels sprouts, broccoli), the industrial drying step 12 is performed preferably at a temperature comprised between 55° C. and 75° C. for a time interval that can vary between 4 hours and 10 hours.

In any case the goal of the industrial drying, provided in step 12, is to reach a condition for which the vegetables (after pulverization) can have a relative humidity comprised between 5% and 20% (the preferred values are those comprised between 12% and 15%).

Once the vegetable of interest has been dried appropriately, it is then possible to perform a step 17 for grinding at least part of the dried vegetable until a flour with a particle size distribution is obtained, understood as the average diameter of each individual particle of shredded vegetable, comprised between a few microns and 1.5 mm.

Grinding can be performed with a mill for food use, therefore performing an actual milling of the dried vegetable.

It is also possible to then subject the obtained flour to a subsequent screening step 18 so as to separate the particles having a larger particle size distribution from those having smaller dimensions.

The vegetable flour thus obtained at this point is ready for distribution and/or industrial use (steps 19).

As described previously, upstream of the vegetable grinding step 17 there is at least one preliminary substep of the type chosen from screening (step 13), washing/cleaning (step 14), humidification (step 15), decortication (step 16), industrial drying of the harvested vegetables (12).

These operations (the complete execution of all of them and/or the execution of at least one of them), although not required in order to obtain a vegetable flour with the characteristics provided by the present disclosure, ensure to obtain a finished product (the vegetable flour) with excellent organoleptic and nutritional characteristics as well as healthy and healthful.

In particular, it is specified that the flour obtained following the grinding step 17 can advantageously be subjected to a further step 20 for separation and selection of a fraction with high protein content; said selected fraction constitutes a rough protein flour 21.

The step 20 can be performed by mechanical separation (by means of separation processes that utilize specific reactions of the ground vegetable to stresses of the vibrational, centrifugal, compression type, as well as the difference in specific gravity of its parts which allows to perform separations by means of appropriately calibrated jets of compressed air), by flotation (process for the separation of solid substances that allows to “select” a higher concentration of the useful fraction; flotation utilizes the different behavior of the materials to be separated with respect to physical phenomena such as surface tension or adhesion or wettability with a liquid used for the operation; the materials are, in fact, wettable or not by the various liquids used and it is possible to modify, with appropriate reagents, known as flotation agents, their natural behavior) and/or by flocculation (flocculation is a chemical-physical process that is a consequence of coagulation for which the colloidal particles that are present in a dispersion join together by heating or by means of the addition of appropriate substances, flocculation agents, in order to produce aggregates of larger size, flocs or floccules, which easily deposit/separate).

The rough protein flour 21 obtained at the end of step 20 contains a specific lipid content, predominantly constituted by vegetable oils (such as for example alcohol esters, hydrocarbons, phytosterols, phospholipids, tocols, terpenes and the like).

The method 1 according to the disclosure can conveniently comprise a defatting step 22, i.e., a step for removal of the oils that are present in the rough protein flour 21, in order to obtain a soluble protein flour 23.

The defatting operations provided in step 22 can be of an exclusively mechanical type or can use specific solvents, in accordance with procedures that are standardized in the food industry.

The soluble protein flour 23 can then be subjected to a further step 24 of extrusion at a temperature comprised between 75° C. and 150° C. (by way of purely non-limiting example, it is specified that optimum results have been obtained with flours originating from Leguminosae by adopting temperatures comprised between 110° C. and 130° C.), and to a further drying step 25 which allows to obtain a vegetable flour with a relative humidity on the order of 30%-50% (preferably but not exclusively approximately 40%).

This flour obtained at the end of the further drying step 25 is a structured vegetable protein flour 26, suitable for the production of meat surrogates.

According to one possible variation of the method 1 according to the disclosure, during a cutting and separation step 27 it is possible to separate the flour 26 into portions suitable for industrial use and/or marketing.

With particular reference to further specific embodiments of the method 1 according to the disclosure, downstream of the grinding step 17, advantageously a step can be provided for the extraction of substances chosen from lipids and carbohydrates from the obtained vegetable flour, so as to provide a low-calorie flour (which can be intended for food use, as an ingredient, or marketed to retail).

In order to have detailed information regarding the chemical-physical characteristics of the vegetable intermediate products being processed, during a substep chosen between a substep that precedes the vegetable grinding step 17 and a substep that follows said grinding step 17, the intermediate products, constituted by the harvested vegetables and/or by the vegetable flour obtained by the grinding the vegetables cited above, are subjected to analysis aimed at measuring the presence of substances chosen from pesticides, mycotoxins, heavy metals and nutritional microelements. These analyses are of the type chosen from gas chromatographies, liquid chromatographies, mass spectrometry, and combinations thereof.

In this manner one obtains an additional check, with respect to the one performed prior to the harvesting of the vegetables to identify the ideal moment for said harvesting (at which the residual concentration of active plant protection ingredients is lower than 0.01 mg/kg, or at lower concentrations, for example 0.005 mg/kg, in the specific cases described earlier) which allows to assess any accumulations of harmful substances that might occur as a consequence of the processes performed on the vegetables after harvesting.

The method 1 according to the disclosure allows a complete and continuous management starting from the seed of the vegetable of interest up to the provision of the flour (using a definition that is widespread in the agroindustrial sector, From Seed to Table).

If the goal is to provide a vegetable protein flour, the first step provided is to identify a suitable vegetable with high protein content (step 2).

In this context, the vegetable is selected from Leguminosae, such as peas (in particular the respective varieties with high protein content), chickpeas, wild peas, beans, lentils, nuts, such as pine nuts, peanuts, almonds, pistachios, cashew nuts, walnut, hazelnuts, and seeds, such as hemp, pumpkin and sunflower. The use of different vegetable matrices, such as for example quinoa, is not excluded.

Once the vegetable suitable for the purpose has been identified, it is necessary (in the specified step 3) to select the vegetable variety thereof that best matches the specifications provided for the vegetable flour that one intends to produce.

If one intends to produce a vegetable flour with high protein content, the ideal nutritional content of a vegetable (intended for the provision of a possible vegetable flour by applying a possible variation of the method 1 according to the disclosure) provides for a protein content that is at least equal to 24% with respect to the dry weight (ideally between 26% and 28%).

If instead one wishes to produce a vegetable flour with low calorie impact, the use of Brassicaceae (for example cauliflower, broccoli, etc.) is privileged, selecting the respective vegetable variety that is most suitable for the production of flours and characterized by the high content of microcomponents of a nutritional kind, establishing calorie ranges that are consistent with the goals to be achieved (for example a calorie content of less than 50 cal/100 g referred to the fresh vegetable matrix or less than 400 cal/100 g referred to the dry product).

If one intends to produce a vegetable flour with high fiber content, it is necessary to identify in the selected vegetable (for example among Chenopodiaceae, such as beet and spinach, and Asteraceae, such as lettuce, chicory, etc.) the vegetable variety that is most suitable for the production of flours with high fiber content and characterized by a high content in microcomponents of a nutritional kind (for example a minimum fiber content equal to 3 g/100 g referred to the fresh vegetable matrix).

The activities related to steps 2, 3, 4 and 5 may be performed generically in an office A, since they do not require specific equipment and/or direct interventions on the field.

Step 4 provides for the choice of the soils suitable to achieve the expected production of the vegetable matrix without using, or in any case reducing to a minimum, the use of pesticides: in order to achieve this result it is necessary to perform studies of the historical data, for example of the so-called farmbooks, the execution of chemical and physical analyses of the soils, the statistical analysis of the weather trends, and many other items of information.

The concept of precision farming has been emerging in recent years: an approach that uses information and communication technologies to improve the farming process. Precision farming is playing an important role in the fourth industrial revolution, also known as Industry 4.0. Precision farming in fact uses information and communication technologies to reduce investment costs and increase both the production and the quality of the obtained vegetable matrices. The concept of quality from this point of view can be expressed as a function of the expected goals. In particular, the system provides for the multilayer mapping 28 of the areas that are the subject of the crops in order to analyze 29 the characteristics of the soils (distribution, shape, chemical characteristics) such as for example available nutrients (soil analyses) and other properties of the soil that can directly or indirectly influence the crops.

The cross-referencing of the information related to the composition characteristics of the soils and to the metabolism/absorption of each crop allows to: adapt/modulate the fertilization 30 in the various regions of the field B; adapt/modulate the application of biostimulants (increase of the health/nutritional value of the vegetable matrices) in the various regions of the field B; adapt/modulate the application of pesticides 31 as a function of the spot detections. The pesticides identified among those with low residuality (a database of pesticides with low residuality is drafted on a historical basis among those allowed by regional codes for the integrated control for the specific crop) are applied exclusively in the areas in which the presence of insects and/or parasites is detected and for the proximate area of 10 m.

By means of this approach it is possible to increase the productivity related to the specific vegetable variety 32 of interest. The choice of the most appropriate vegetable varieties (step 5) also is performed on the basis of the characteristics of the soil (determined in step 4) in which the cultivation is performed, so as to maximize yield.

Among the preliminary choices to be performed in an “office” A (meaning any environment in which it is possible to analyze the data and process them), there is the selection of varieties of seeds that are not genetically modified, in order to ensure that the vegetable flour that will be produced is an extremely natural product, ideal for a healthy food regimen.

It is furthermore possible to perform seed germinability tests on the specific batches of seeds purchased, so to verify the aptness of the seed, if placed in suitable external temperature, community and lighting conditions, to germinate and produce a new plant.

The method according to the disclosure provides for a series of successive activities (identified by steps 6, 8 and 10) which are performed in the field (these being typically agronomic activities), in which the use of analyses (steps 7 and 9) to be performed in a laboratory C is provided.

It is then also possible to proceed with a verification of the crop during the vegetative/cultivation cycle on the part of technicians operating on the field B, sharing with the manager of the farm a list of possible allowed pesticides.

By virtue of the use of precision farming systems for the verification of the crop during the vegetative/cultivation cycle (verification by satellite monitoring or by means of drones to identify, within the fields, the only regions that would require applications of pesticides) a very specific and detailed verification is possible. The control systems provided by precision farming also have the goal of limiting the presence of factors that can lead to the forming of secondary metabolites (produced by plants in stress situations) which are normally present in vegetables and can also have dual nutritional/antinutritional effects (for example influencing the presence of phytates, saponins or polyphenols/tannins).

The company technician chooses, together with the farm manager, the pesticide to apply as a function of the low residuality and of the preharvest interval (using a database of low residuality pesticides and a mathematical modeling system which, as a function of the climate characteristics, estimates the time for the ripening/harvesting and the residuality of the pesticide, which must be at most equal to 0.01 mg/kg. It is specified that one goal of the present disclosure might be to further reduce the residual content of pesticides, ensuring that it is even lower than 0.005 mg/kg, a condition that can be provided in all cases in which the analytical method allows this identification for the specific pesticide molecule that is the subject matter of the investigation.

Moreover, the possibility is not excluded to adopt specific biostimulants (i.e., substances having a specific action, based on natural components and molecules, capable of acting on the primary and secondary metabolism of plants) to ensure the bioavailability and the absorption of molecules of nutritional interest (for example minerals such as iron, zinc, calcium, magnesium, selenium and iodine, which might “enhance” the vegetable during its development and growth, increasing its nutritional content).

During step 6, periodic samplings are performed and iterated during the growth of the vegetables (step 7, resorting to an analysis laboratory C) and prior to harvesting (step 7, resorting to an analysis laboratory C) for analysis and verification of the absence of pesticides. More correctly, an attempt will be made to reach a condition of residual presence of pesticides lower than a limit threshold of 0.01 kg/kg (specifying that in any case one attempts to reach an even more ambitious goal, setting the limit threshold to a value of 0.005 mg/kg if the analysis method allows the identification of such a concentration of the molecule of the pesticide).

In any case, prior to the harvesting operations if a step 11 for natural drying of the vegetables on the field B is provided, checks are performed which are aimed at estimating the residual humidity of the matrices dried in the field and of the respective content of mycotoxins and/or heavy metals. Of course harvesting will be started if the absence of pesticides and mycotoxins is detected (or, in more specific terms, a respective presence lower than threshold values identified as negligible by the standards).

The checking of any presence of mycotoxins and/or heavy metals also is performed in the laboratory C: this analysis might be a quali-quantitative analysis by gas chromatography and liquid chromatography, both interfaced with mass spectrometry for the identification and quantification of the molecules of pesticides and/or derivatives thereof and of mycotoxins. In any case, resorting to a quali-quantitive analysis by plasma coupled inductively with mass spectrometry for the identification and quantification of heavy metals is not excluded. In this context, a continuous (at least quarterly) updating of the databases related to the investigated molecules and of the methods for their analysis will be performed, introducing in this database new molecules of interest (pesticides and mycotoxins) if they are identified.

All these procedures can be implemented by means of accredited/accreditable analytical methods.

Essentially, upon an extremely rigorous application aimed at obtaining a finished product of excellent quality, it is specified that checking for the absence of the harmful/damaging molecules of interest is performed by adopting three distinct methods: execution of the analysis in pre-harvesting on the fresh vegetable matrices, repetition of the analysis during the transfer of the fresh vegetable matrices; final verification on the finished products.

Once the harvesting of the vegetables has been performed, one then proceeds with a series of activities within a processing facility D.

It is specified that any operations for further drying 12 of the vegetables are preferably performed by means of methods that provide exclusively for flows of hot air and/or permanence in environments with a controlled atmosphere (low values of residual humidity and controlled temperatures), taking care to avoid the use of chemical substances. The use of physical means such as inert gases, ozone and others already in use in the food industry is instead not excluded.

As mentioned earlier, after the drying step 12 it is possible to provide specific and additional monitoring operations of the mycotoxin content, in order to safeguard the quality of the flour that one intends to produce.

If one operates on vegetables that belong to Leguminosae or on nuts, or on seeds or with quinoa, it is necessary to provide the decortication step 16 of the physical type for the dried vegetable matrices.

The grinding step 17 is of the physical type and can be performed by means of mills intended for food products, for example of the type with millstones, gears, teeth and the like. The adoption (if necessary for specific applications) of different types of mill (such as ball mills or screw feeder mills) is not excluded.

It is then also possible to provide steps for the physical separation of a part with high protein content of the flour from the remaining ground vegetable: this activity can be performed by means of separation steps 20 (by mechanical separation and/or flotation and/or flocculation), as well as by means of extrusion steps 24.

The agronomic choices that represent central factors the achievement of the goals that characterize the intermediate/finished products (flours) must be made to ensure:
the absence of genetically modified organisms among the vegetables used (merely by way of example, the vegetable varieties not genetically modified for yellow protein peas are the Navarro variety and the Lapponi variety);
the presence of heavy metals below the limits allowed for the matrix (preliminary analysis of the soils for the use of soils that do not condition the excessive absorption of heavy metals);
the presence and bioavailability of microelements of nutritional importance naturally present in vegetable matrices (choice of the varieties that facilitate absorption).

The vegetable flour according to the disclosure comprises particles of vegetables of the type obtained by natural selection and hybridization, i.e., not genetically modified (seeds classified as GMO are excluded during vegetable selection), chosen among Leguminosae, Brassicaceae, Chenopodiaceae, Asteraceae, seeds and nuts.

Said vegetable flour has a residual concentration of active plant protection ingredients lower than 0.01 mg/kg, although the preferred possibility is provided to produce flours with residual concentrations of pesticides no greater than 0.005 mg/kg if the analysis methods allow to detect such a low concentration of the specific pesticide molecule.

Furthermore, these flours have a residual concentration of mycotoxins of less than 2000 μg/kg and a residual concentration of heavy metals of less than 0.20 mg/kg.

The ground vegetables that constitute the particles of the flour may advantageously be constituted for at least 60% by:
Leguminosae, chosen from peas, chickpeas, wild peas, fava beans, beans, lentils;
nuts, chosen from pine nuts, peanuts, almonds, pistachios, cashew nuts, walnuts, hazelnuts;
seeds, chosen from hemp seeds, pumpkin seeds, fennel seeds, chia seeds, linen seeds, sesame seeds, poppy seeds and sunflower seeds;
Chenopodiaceae, in particular quinoa.

Obviously, the possibility is also provided to provide a vegetable flour that is the result of any combination of the vegetable species listed above. In all these cases the vegetable flour obtained is a vegetable flour with a protein content of more than 15%.

This type of flour can be used to produce surrogates of meat and/or used in specific food recipes.

According to one possible alternative version, it is specified that the ground vegetables can be conveniently constituted for at least 60% by:
Brassicaceae, chosen from cabbages, turnips, cauliflowers, rapeseeds, Brussels sprouts, broccoli;
Chenopodiaceae, chosen from all the botanical varieties of Beta vulgaris and spinach;
Asteraceae, lettuce, dandelion, chicory, endive, thistle, artichoke, marigold.

In this case, the vegetable flour has a fiber content of more than 10%.

Appropriate selections of the raw materials, as well as specific operations for defatting and/or removal of a fraction of the carbohydrate content, furthermore allow to produce flours with a very low calorie content.

It has thus been seen that by means of the present disclosure it is possible to identify a class of vegetable flours characterized by the high protein content and obtained mainly from Leguminosae (or nuts or seeds or quinoa), a class of vegetable flours characterized by the low calorie content obtained mainly from Brassicaceae (or Chenopodiaceae or Asteraceae) and a class of vegetable flours characterized by the high content in fibers and micronutrients (for example betaines, glucosinolates, minerals) obtained mainly by foliate vegetables (for example spinach, endive, beet, arugula, etc.).

These flours can be used individually or can also be mutually combined. These flours are obtained by using vegetable matrices that are verified and analyzed from seed to harvesting as well at the end of the transformation process (i.e., throughout the production chain).

The possibility to perform specific treatments on the soil or on the seeds or on the plants in order to increase the content of specific elements (for example increase the content of selenium or iodine or iron or zinc, etc.) ensures the possibility to give specific nutritional properties to the vegetable flours produced.

It is possible to provide for the use of the flour obtained by means of method 1 as an intermediate product to perform a subsequent extraction of the fractions of interest (protein, fibers, starch).

If the flours are obtained from the processing of yellow peas, chickpeas, borlotti beans and the like, it is possible to provide for sending the obtained flours to companies specialized in the extraction of raw proteins.

The direct marketing of the vegetable flours is in any case not excluded, for the production of pasta and bakery products (using as ingredients flour of spinach, flour of cauliflower, broccoli flour, etc.).

Rough protein flours 21 of legumes (yellow protein pea, chickpeas, borlotti beans) also might be used as an intermediate product for the production of soluble protein flour 23 and/or texturized proteins 26.

The soluble protein flours 23 have an assured industrial use as ingredients in food formulations (for example products for vegetarians) or as an intermediate product for the production of texturized proteins 26.

Texturized proteins 26 are used as ingredients in food formulations for vegetarians and for the production of meat substitutes. This type of flour 26 is also suitable for direct sale for domestic use in the preparation of meat substitute foods.

Advantageously, the present disclosure solves the problems described previously, proposing a method 1 for the production of vegetable flours that provides assurances regarding the absence of genetically modified organisms in the produced flours.

Conveniently, the method 1 according to the disclosure minimizes the presence of pesticide residues in the produced flours.

Favorably, the method 1 according to the disclosure minimizes the presence of substances that are harmful for humans and animals in the produced flours.

Profitably, the vegetable flour that is produced has optimum nutritional properties.

Positively, the vegetable flour according to the disclosure has optimum organoleptic properties.

Validly, the method 1 for the production of vegetable flours and the at least one respective vegetable flour produced are relatively simple to provide in practice and have substantially modest costs: these characteristics render the method 1 and any associated vegetable flour according to the disclosure innovations of assured application.

The disclosure thus conceived is susceptible of numerous modifications and variations, all of which are within the scope of the accompanying claims; all the details may furthermore be replaced with other technically equivalent elements.

In the examples of embodiment shown, individual characteristics, given in relation to specific examples, may actually be interchanged with other different characteristics of other examples of embodiment.

In practice, the materials used, as well as the dimensions, may be any according to the requirements and the state of the art.

1-12. (canceled)

13. A method for the production of vegetable flours, the method including the following steps:
identifying a vegetable with specific and predefined nutritional properties of interest and selecting, among all the existing vegetable varieties of said vegetable, the vegetable varieties best suited for the production of flours;
performing a preliminary chemical, physical, and pedological analysis of the soils intended for cultivation, to identify composition, hydrological characteristics, and to verify the absence of pathogens, pest organisms, and pollutants;
selecting, among natural seeds that are not genetically modified, the seeds most suitable for the soil parameters identified previously;
performing iterated periodic checks on the vegetable species that grow after seeding, to detect biotic adversities and/or infestations thereof,
performing at least one plant protection treatment by using active ingredients selected from insecticides, herbicides, acaricides, limacides, and fungicides;
close to a harvesting period, performing iterated periodic spot checks of the vegetables to measure the residual concentration of active plant protection ingredients;
at samplings to evaluate the residual concentration of active plant protection ingredients lower than 0.01 mg/kg, performing the harvesting of the cultivated vegetables;
performing a drying of the vegetables which comprises at least one step of pre-drying in the field and their harvesting; and
grinding at least one part of the dried vegetable until a flour is obtained with a particle size distribution, understood as the average diameter of each individual particle of shredded vegetable, comprised between a few microns and 1.5 mm.

14. The method for the production of vegetable flours according to claim 13, wherein upstream of said vegetable grinding step there is at least one preventive sub-step chosen from screening, washing/cleaning, humidification, decortication, and drying of the harvested vegetables.

15. The method for the production of vegetable flours according to claim 14, wherein said flour obtained following said grinding step is subjected to a step for selection and separation of a fraction with high protein content, said selected fraction constituting a raw protein flour.

16. The method for the production of vegetable flours according to claim 15, further including a step of defatting, removal of the oils that are present, from said raw protein flour to obtain a soluble protein flour.

17. The method for the production of vegetable flours according to claim 16, wherein said soluble protein flour is subjected to an extrusion process at a temperature comprised between 75° C. and 150° C. and to a further drying process to obtain a structured vegetable protein flour suitable for the production of meat surrogates.

18. The method for the production of vegetable flours according to claim 13, further comprising, downstream of said grinding step, a step of extraction of substances chosen from lipids and carbohydrates from said vegetable flour to provide a low-calorie flour.

19. The method for the production of vegetable flours according to claim 13, wherein during a sub-step chosen between a sub-step that precedes said grinding step of said vegetables and a sub-step that follows said grinding, the intermediate products, constituted by the harvested vegetables and/or by the vegetable flour, are subjected to analyses aimed at measuring the presence of substances chosen from pesticides, mycotoxins, heavy metals and nutritional microelements, said analyses being chosen from gas chromatographies, liquid chromatographies, mass spectrometry, and combinations thereof.

20. The method for the production of vegetable flours according to claim 13, wherein the investigation aimed at verifying the residual concentration of lower active plant protection ingredients is conducted with respect to a maximum threshold value equal to 0.005 mg/kg, prior to the harvesting of the cultivated vegetables.

21. A vegetable flour comprising particles of vegetables obtained by natural selection and hybridization, i.e., not genetically modified, chosen from Leguminosae, Brassicaceae, Chenopodiaceae, Asteraceae, seeds and nuts, the vegetable flour comprising:
a residual concentration of active plant treatment ingredients lower than 0.01 mg/kg,
a residual concentration of mycotoxins lower than 2000 μg/kg, and
a residual concentration of heavy metals lower than 0.20 mg/kg.

22. The vegetable flour according to claim 21, wherein the residual concentration of lower active plant protection ingredients is lower than 0.005 mg/kg.

23. The vegetable flour according to claim 21, wherein said ground vegetables that constitute the particles of said flour are constituted for at least 60% by
Leguminosae, chosen from peas, chickpeas, wild peas, fava beans, beans, lentils;
nuts, chosen from pine nuts, peanuts, almonds, pistachios, cashew nuts, walnuts, hazelnuts;
seeds, chosen from hemp seeds, pumpkin seeds, fennel seeds, chia seeds, linen seeds, sesame seeds, poppy seeds and sunflower seeds;
Chenopodiaceae;
combinations thereof, and
said vegetable flour having a protein content of more than 15%.

24. The vegetable flour according to claim 21, wherein said ground vegetables that constitute the particles of said flour are constituted for at least 60% by
Brassicaceae, chosen from cabbages, turnips, cauliflowers, rapeseeds, Brussels sprouts, broccoli;
Chenopodiaceae, chosen from all the botanical varieties of Beta vulgaris and spinach;
Asteraceae, lettuce, dandelion, chicory, endive, thistle, artichoke, marigold; and
said vegetable flour having a fiber content of more than 10%.
